(19) United States
(12) Patent Application Publication
(10) Pub. No.: US 2019/0380527 A1
(43) Pub. Date: Dec. 19, 2019

(54) COFFEE MACHINE AND METHOD FOR PREPARING FILTERED COFFEE

(71) Applicant: MELITTA EUROPA GMBH & CO. KG, Minden (DE)

(72) Inventors: Andreas SACHTLEBEN, Minden (DE); Sven NEUHAUS, Bad Oeynhausen (DE)

(73) Assignee: MELITTA EUROPA GMBH & CO. KG, Minden (DE)

(21) Appl. No.: 16/441,034

(22) Filed: Jun. 14, 2019

(30) Foreign Application Priority Data
Jun. 18, 2018 (DE) 10 2018 114 588.8

(51) Int. Cl. A47J 31/06; A47J 31/44

(52) U.S. Cl. CPC A47J 31/0631; A47J 31/4478

(57) ABSTRACT

A coffee machine includes a device for generating hot water, a device for distributing the hot water and a filter basket arranged below the distribution device into which a filter containing coffee grounds can be inserted. The distribution device includes a rotatably positioned outlet member with at least two outlet openings which can be rotated by a drive during a brewing operation. Also disclosed is a method for brewing coffee for which an outlet member is rotated above a filter basket.

### CROSS-REFERENCE TO RELATED APPLICATIONS

This application claims priority to German Application No. 10 2018 114 588.8, filed on Jun. 18, 2018, the disclosure of which is incorporated herein by reference in its entirety.

### BACKGROUND OF THE INVENTION

The present invention relates to a coffee machine with a device for producing hot water, a device for distributing hot water, and a filter basket arranged below the distributing device into which a filter and coffee grounds can be inserted. It also relates to a method for preparing filtered coffee.

German patent document DE 10 2015 121 634 A1 discloses a coffee machine with a discharge device that contains multiple outlet openings, wherein a switch can be used to control the amount of hot water flowing through the inside or the outside discharge openings. The extraction of the coffee grounds and thus the coffee taste are purposely influenced in this way. The disadvantage of this static adjustment is that a uniform moistening and thus an optimum extraction cannot always be achieved.

Preparing coffee manually has advantages since it allows a user-controlled moistening because the water is poured manually onto the coffee grounds in the filter, thereby resulting in a good extraction. The brewing duration can also be optimally controlled by the speed of the manually supplied water. However, when preparing a larger amount of coffee, the manual preparation is comparably involved.

### SUMMARY OF THE INVENTION

It is therefore the object of the present invention to make available a coffee machine and a method for preparing filtered coffee which optimizes the extraction by mimicking the manual preparation when supplying the hot water to the coffee grounds.

The above and other objects are achieved by the provision of a coffee machine, which in one embodiment includes: a hot water device for producing hot water; a distribution device, including a rotatably positioned outlet member with at least two outlet openings, arranged to receive the hot water from the hot water device and adapted to distribute the hot water via the rotatably positioned outlet member; a filter basket arranged below the distribution device into which a filter and coffee grounds are insertable; and a drive to rotate the rotatably positioned outlet member during a brewing operation of the coffee machine.

According to another aspect of the invention there is provided a method for preparing filtered coffee which according to one embodiment includes generating hot water and supplying the hot water to a distribution device with a rotatable outlet member having at least two outlet openings; and rotating the rotatable outlet member while hot water simultaneously flows via at least one of the at least two outlet openings over coffee grounds inside a filter basket positioned below the outlet member.

The coffee machine according to the invention comprises a hot water distribution device that is provided with a rotatably positioned outlet member, having at least two outlet openings. To ensure a uniform wetting of the coffee grounds, the outlet member can be rotated with the aid of a drive. As a result, the coffee grounds are not wetted through a stationary feeding-in of water below one or several outlet openings, but the outlet member is moved for wetting a larger area of the coffee grounds during the brewing operation, thus ensuring a more uniform extraction.

The outlet openings are preferably arranged at a distance to a rotational axis of the outlet member. During the rotation of the outlet member, a circular area can thus be wetted around the rotational axis of each outlet opening.

For a targeted control of the extraction, the outlet member can preferably be rotated in opposite directions. A switchgear assembly can be provided for this, which allows the hot water to flow through different outlet openings, depending on the rotational direction of the outlet member. The switchgear assembly can be designed to operate electronically, electrically or mechanically, wherein the rotation of the outlet member is preferably used for a switching operation.

A separating wall is advantageously provided on the outlet member, at least between two outlet openings. A guide element can be provided above the outlet member which supplies the hot water optionally to a first side of the separating wall or to the opposite-arranged second side. A movement of the guide element relative to the outlet member can thus bring about a switching operation for optionally supplying hot water to the outlet openings arranged on the first side or the outlet openings arranged on the second side. The guide element can be embodied rotating over a specified angle region, relative to the outlet member, in particular ranging from 20° to 60°.

According to a further embodiment, the guide element has an outlet opening on a ring-shaped channel. The outlet opening supplies hot water to the outlet member, wherein the outlet opening can be positioned at different locations above the outlet member.

With the method according to the invention, hot water is guided to an outlet member which allows the hot water to flow via at least one outlet opening onto the coffee grounds inside a filter basket arranged below and which simultaneously also rotates. The rotational direction of the outlet member is preferably changed after a specified time interval. In the process, the hot water can flow in a first rotational direction through at least a first outlet opening in the outlet member and in a second rotational direction through at least a second outlet opening in the outlet member, thereby ensuring an optimized wetting of the coffee grounds, similar to a manual brewing operation.

### BRIEF DESCRIPTION OF THE DRAWINGS

In the following, the invention is explained in further detail with the aid of an exemplary embodiment and reference to the enclosed drawings, which show in:

FIG. 1 is a perspective view of a coffee machine according to the invention;

FIG. 2 is a view from above of the coffee machine according to FIG. 1;

FIG. 3 is a view from above of the drive for the coffee machine according to FIG. 1;

FIGS. 4A and 4B are two views of the water-supply region for the coffee machine according to FIG. 1;

FIG. 5 is a sectional view through the water-supply region for the coffee machine according to FIG. 1;

FIG. 6 is a different sectional view through the water-supply region for the coffee machine according to FIG. 1.

FIG. 6A is a sectional view of the outlet member shown in FIG. 1.

FIG. 6B is a perspective view of the outlet member shown in FIG. 1.

FIG. 7 is a sectional view like FIG. 6 of the water-supply region for the coffee machine according to FIG. 1.

FIGS. 8A to 8D are different views of a bearing ring for the outlet member of the coffee machine according to FIG. 1;

FIG. 8E is a sectional view showing a connection between the bearing ring and the outlet member;

FIGS. 9A to 9C are several views of a guide element for hot water for the coffee machine according to FIG. 1;

FIG. 10A is a plan view of the outlet member for supplying hot water and FIG. 10B is a sectional view along line B-B in FIG. 10A;

FIGS. 11A and 11B are two views of the outlet member with the outlet nozzle at different positions;

FIGS. 12A and 12B are two views of the outlet member with the outlet nozzle at different positions; and

FIGS. 13A and 13B are two views of the water supply to the coffee machine, showing the outlet member in different positions.

### DETAILED DESCRIPTION OF THE INVENTION

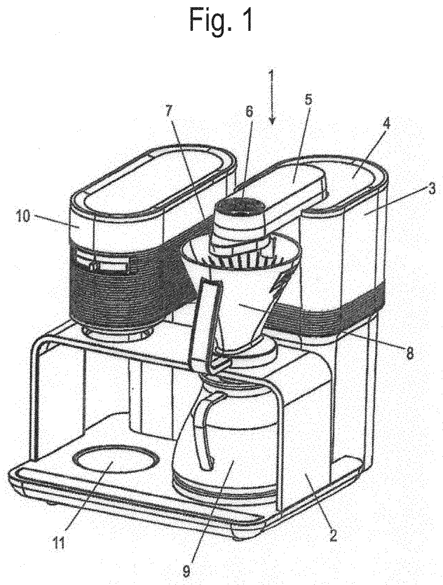

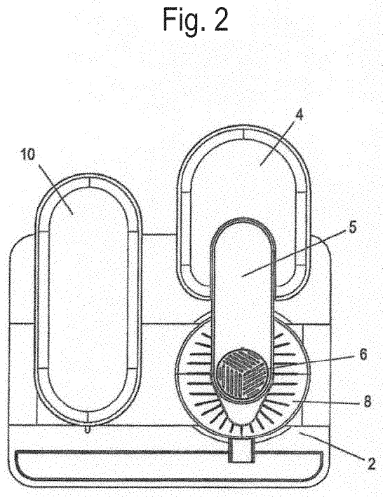

Referring to FIGS. 1 and 2, there is shown a coffee machine 1 that comprises a housing 2 with thereon provided reservoir 3 for the water. The reservoir 3 is closed off with a removable lid 4 and can be filled with water. The coffee machine is provided with a pump and a heating device for producing hot water which is supplied via a feed line 5 to an outlet member 7. The outlet member 7 is located above a filter basket 8, in particular taking the shape of a truncated cone, which is suitable for holding a filter paper insert with coffee grounds. The filter basket 8 is attached to be removable to the housing 2 of the coffee machine 1 and is arranged above a container 9, for example a Thermos® jug or a glass carafe for brewed coffee.

The coffee machine 1 optionally is also provided with a grinder 10 for grinding fresh coffee beans to be supplied to a container at an intake 11, so that the freshly ground coffee can be filled into a filter paper insert in the filter basket 8.

The outlet member 7 is arranged rotating, relative to the feed line 5, and can thus supply hot water during a rotational movement to the coffee grounds. A ventilation lid 6 is furthermore provided at the top of the feed line 5 which contains openings for ventilating the feed line 5.

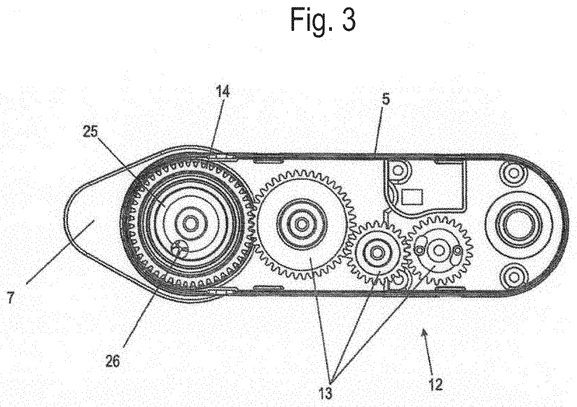

FIG. 3 shows the outlet member 7 with a drive 12, for example provided with an electric motor (not shown). The drive 12 comprises a plurality of gears 13 that form a gear mechanism, wherein the number of gears can be selected depending on the design of the feed line 5. The gears 13 of the mechanism can drive a gear rim 14 which is indirectly connected to the outlet member 7 for rotating the outlet member 7, wherein the outlet member 7 can be rotated in opposite directions.

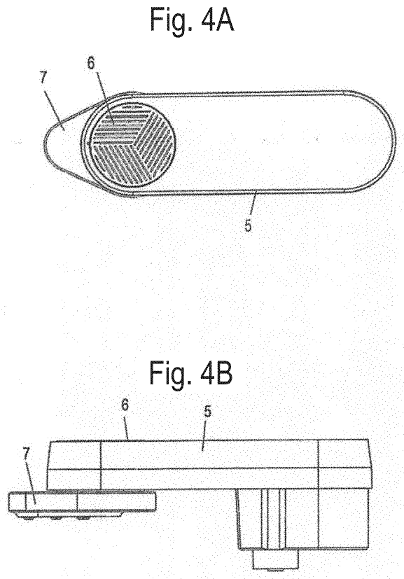

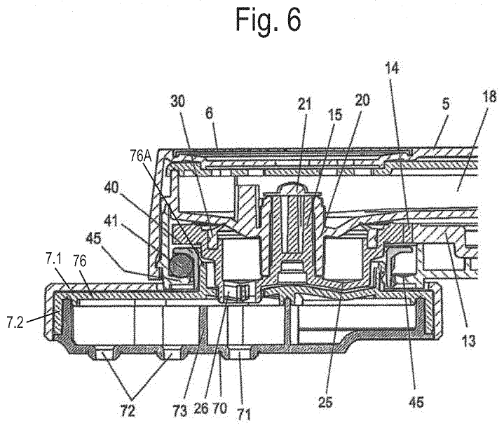

FIGS. 4A and 4B show the region of the feed line 5 with the ventilation lid 6 and the outlet member 7, as seen from the outside. An intake is provided on the feed line 5 through which the hot water is supplied by a pump and a heating device (not shown) to a channel 18 (see FIG. 6) of the feed line 5, which intake is arranged above the gear mechanism and is inclined slightly toward the outlet member 7.

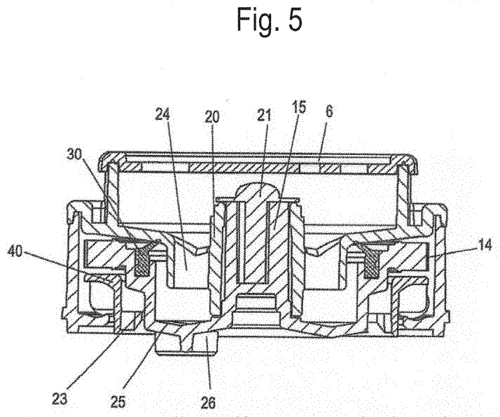

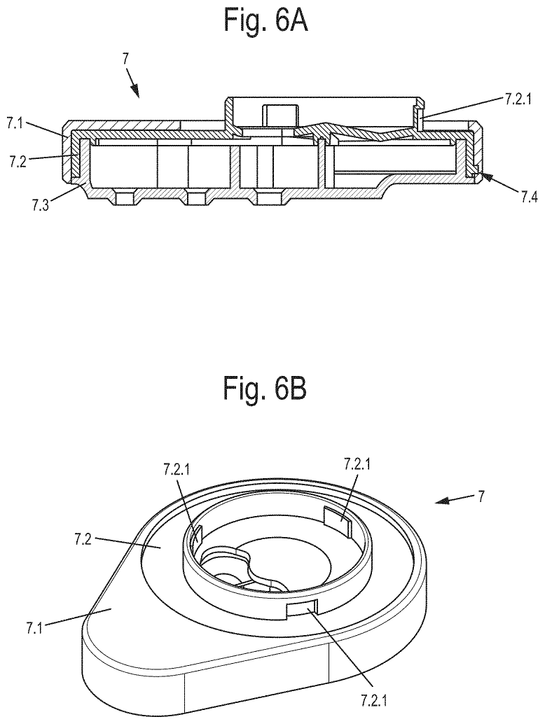

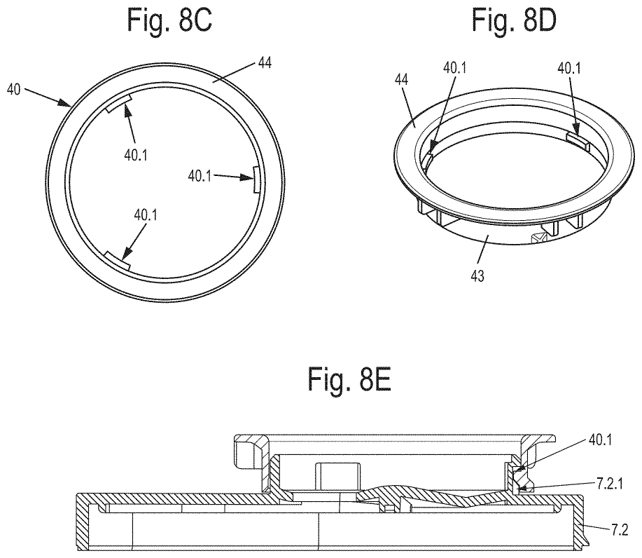

Referring additionally to the sectional views in FIGS. 5 to 7, the plurality of gears 13 drives a gear mechanism 14 (see also FIGS. 3, 6, 9A and 9B) that is embodied integrally with a guide element 23 having a ring-shaped intake 25 (see also FIGS. 9A-9C). The guide element 23 has an internal axis 15 with a screw 21 inserted therein for axial security. With a radially projecting flange section, the screw 21 overlaps a stationary arranged inside sleeve 20. The hot water is guided via outlet openings 24 into the ring-shaped intake 25 of the guide element 23 which is rotated by the drive. From the ring-shaped intake 25, the hot water flows off through an opening in an outlet nozzle 26 that projects downward from the intake 25. The guide element 23 is furthermore provided with a seal 30 (FIGS. 5 and 7) having a sealing lip for sealing the area between the guide element 23 and a housing section of the coffee machine.

The outlet member 7 is held in place on a rotatable bearing ring 40 with the aid of stop elements. Referring to FIG. 6A, the outlet member 7 consists of a decorating cover 7.1, the outlet lid 7.2 and the outlet bottom 7.3. The outlet lid 7.2 and the outlet bottom 7.3 are connected by ultrasonic welding. The decorating cover 7.1 is fixed by snap hook connection 7.4 with the outlet lid 7.2. The outlet lid 7.2 has pockets 7.2.1 evenly distributed on an upwards extending wall as also shown in FIG. 6B.

The bearing ring 40 is positioned rotating on the housing 2 via spherical rolling elements 41, wherein the rolling elements 41 roll off a circular track 45 and support the bearing ring 40. The outlet member 7 is held securely and torque-proof on the bearing ring 40, which rotates easily relative to the housing 2. The bearing ring 40 is embodied angular, with one leg 44 in the form of a flange projecting over the rolling elements 41, and another vertical leg 43, approximately perpendicular to leg 44, holding the outlet member 7. The outlet member 7 is provided on a bottom 70 with an inside outlet opening 71 and two outside openings 72 which are separated by a separating wall 73. Embodied on one upper part 76 of outlet lid 7.2 of the outlet member 7 is a bow-shaped opening 32 into which projects the outlet nozzle 26. Fastening means 76A are furthermore embodied on the upper part 76, which means are secured on the bearing ring 40.

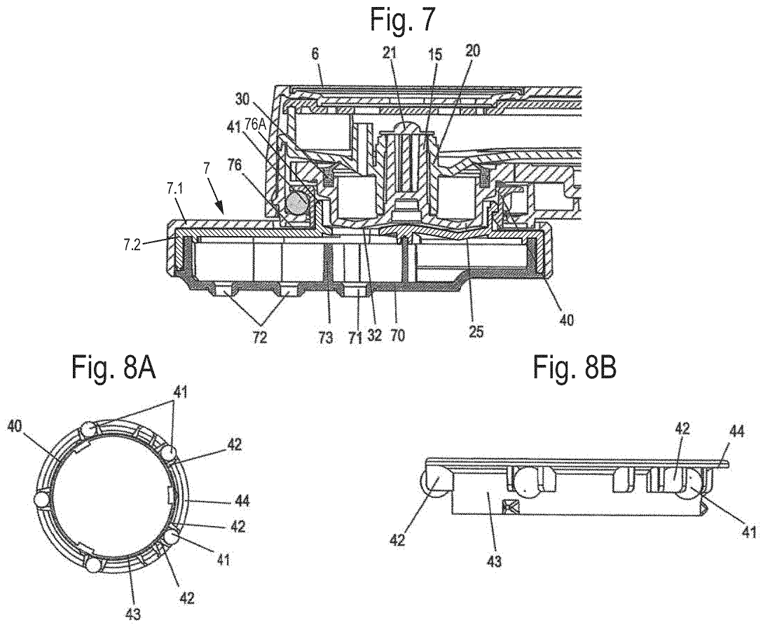

The bearing ring 40 is shown in further detail in FIGS. 8A to 8E. The bearing ring is embodied angle-shaped, as seen in the sectional view of FIG. 8B, with the upper leg/flange 44 that is supported on the rolling elements 41. The vertically positioned inside ring 43 is furthermore provided which holds the outlet lid 7.2. As shown in FIG. 8C and 8D, the bearing ring 40 has 3 extensions 40.1 on the inner side of the inside ring 43. The flange 44 and the inner ring 43 with extensions 40.1 shape the bearing ring 40. The extensions 40.1 dive into pockets 7.2.1 (see FIG. 8E) of the outlet lid 7.2, thus connecting the outlet member 7 with the bearing ring 40 with a latch connection. Each rolling element 41 is guided by two bar-type pushers 42 (FIGS. 8A, 8B) so that the distance between the rolling bodies 41 remains essentially constant.

FIGS. 9A to 9C show the guide element 23 in further detail. The guide element comprises the ring-shaped intake 25 with thereon embodied outlet nozzle 26. The integrally embodied gear ring 14 is provided along the outer circumference.

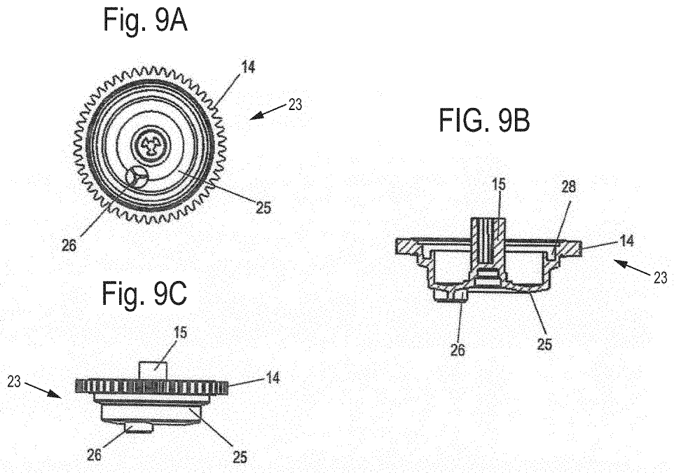

FIG. 10A shows a view from above of the outlet member 7 which is provided on the top with the bow-shaped opening 32, below which the inside outlet opening 71 is visible. The bow-shaped opening 32 is part of the outlet lid 7.2. The outlet opening 71 is part of the outlet bottom 7.3 (see FIG. 10B). Inside the bow-shaped opening 32, the outlet nozzle 26 can optionally be arranged on a first side of the separating wall 73 or a second side of the separating wall 73, so that the inside outlet opening 71 or the outside openings 72 can be supplied with hot water.

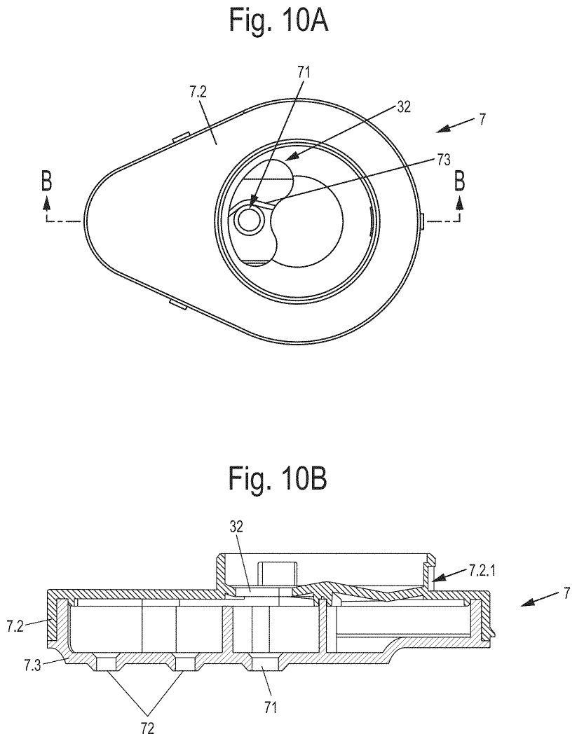

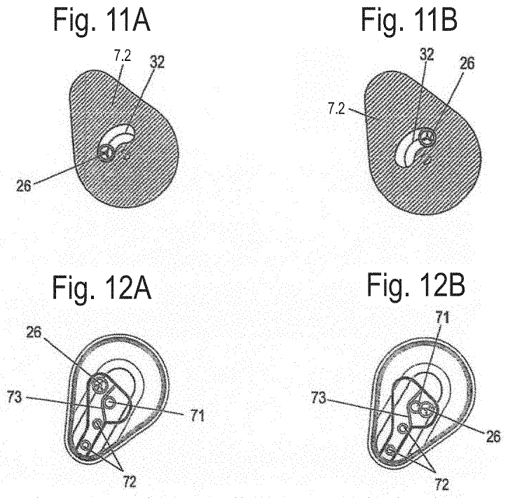

In FIGS. 11A and 12A, the outlet nozzle 26 is arranged such that the two outer outlet openings 72 are supplied with hot water. Once the rotational direction of the motor changes, the outlet nozzle 26 is swiveled along the bow-shaped opening 32, so that it can move the outlet member 7 in the opposite rotational direction. As a result, the outlet nozzle 26 moves relative to the outlet member 7 and is arranged on the opposite side of the separating wall 73, so that the inside outlet opening 71 is now supplied with hot water (FIGS. 11B and 12B).

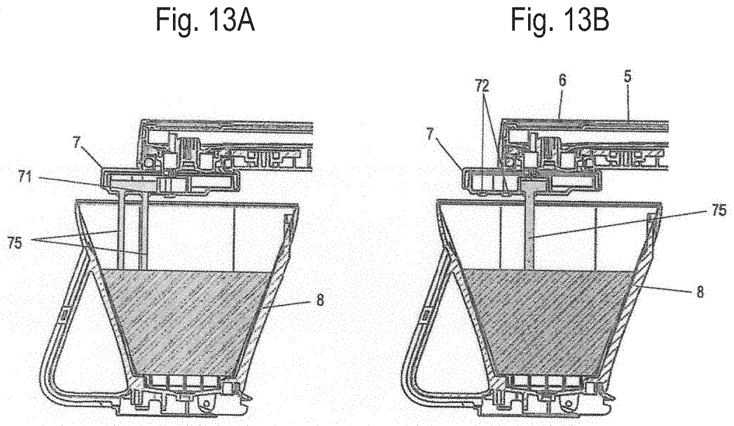

This switching operation is shown once more schematically in FIGS. 13A and 13B. The two outside outlet openings 72 are optionally supplied with hot water which is then dispensed along a circular path onto the coffee grounds contained in the filter basket 8 (FIG. 13A), or the inside outlet opening 71 is supplied with hot water which is then also dispensed along a circular path onto the coffee grounds (FIG. 13B).

In the example shown, the outlet member 7 has three outlet openings 71 and 72. Of course, the number of outlet openings 71 and 72 can be varied and the shape can also be changed so that these can be embodied as slits for example.

In addition, other mechanical assemblies can be used to ensure that during a change in rotation the various outlet openings are supplied with hot water.

The change in the rotation can occur, for example at intervals between 10 s and 1 minute, so that following the brewing operation in a specified region, the mechanism stops briefly to allow the coffee grounds upon which water has been poured to settle again. For a more uniform wetting of the coffee grounds, intervals of between 15 s and 25 s have proven useful.

It will be understood that the above description of the present invention is susceptible to various modifications, changes and adaptations, and that the same are intended to be comprehended within the meaning and range of equivalents of the appended claims.

What is claimed is:

1. A coffee machine, comprising:
a hot water device for producing hot water;
a distribution device, including a rotatably positioned outlet member with at least two outlet openings, arranged to receive the hot water from the hot water device and adapted to distribute the hot water via the rotatably positioned outlet member;
a filter basket arranged below the distribution device into which a filter and coffee grounds are insertable; and
a drive to rotate the rotatably positioned outlet member during a brewing operation of the coffee machine.

2. The coffee machine according to claim 1, wherein the outlet openings are arranged at a distance to a rotating axis of the rotatably positioned outlet member.

3. The coffee machine according to claim 1 wherein the drive is adapted to drive the rotatably positioned outlet member in opposite directions.

4. The coffee machine according to claim 1, wherein the drive includes a switch assembly to allow the hot water to flow through different outlet openings depending on a rotational direction of the rotatably positioned outlet member.

5. The coffee machine according claim 1, further including a separating wall between the at least two outlet openings on the rotatably positioned outlet member.

6. The coffee machine according to claim 5, further including a guide element above the rotatably positioned outlet member which supplies the hot water optionally to one side of the separating wall or to an opposite-arranged second side of the separating wall.

7. The coffee machine according to claim 6, wherein the guide element is rotatable by the drive within a specified angle region, relative to the rotatably positioned outlet member.

8. The coffee machine according to 7, wherein the guide element includes a ring-shaped channel having an outlet nozzle.

9. The coffee machine according to claim 8, wherein the rotatably positioned outlet member includes an upper part with a curved opening, the outlet nozzle of the ring-shaped channel projects downward into the curved opening, and the rotatably positioned outlet member is rotatable via the guide element.

10. The coffee machine according to claim 9, further including a bearing ring supported by a plurality of rolling elements, wherein the rotatable outlet member is held securely and torque proof on the bearing ring and is rotatable with the bearing ring via the plurality of rolling elements.

11. The coffee machine according to claim 10, wherein the bearing ring includes an inner ring that securely holds the rotatable outlet member against rotation relative to the bearing ring.

12. A method for preparing filtered coffee, comprising the steps of:
generating hot water and supplying the hot water to a distribution device with a rotatable outlet member having at least two outlet openings; and
rotating the rotatable outlet member while hot water simultaneously flows via a selected one of the at least two outlet openings over coffee grounds inside a filter basket positioned below the outlet member.

13. The method according to claim 12, wherein the rotating step includes changing a rotational direction of the outlet member after a specified interval.

14. The method according to claim 13, further including conducting the hot water in a first rotational direction of the outlet member through at least a first one of the at least two outlet opening on the outlet member and conducting the hot water in a second rotational direction of the outlet member through at least a second one of the at least two outlet openings on the outlet member.
